(19) United States
(12) Patent Application Publication
(10) Pub. No.: US 2020/0158169 A1
(43) Pub. Date: May 21, 2020

(54) Bearing Arrangement of a Bevel Gear Drive and Application of the Bearing Arrangement

(71) Applicant: ZF Friedrichshafen AG, Friedrichshafen (DE)

(72) Inventors: Thomas Bergmann, Passau (DE); Paul Lenz, Waldkirchen (DE); Klaus Alesch, Untergriesbach (DE); Alexander Enderl, Vilshofen (DE); Julian Haller, Thymau (DE); Rudolf Neumüller, Buechlberg (DE); Manuel Bauer, Tittling (DE); Peter Haselberger, Mauth (DE); Daniela Wagner, Egglham (DE); Daniel Dudek, Salzweg (DE)

(21) Appl. No.: 16/683,832

(22) Filed: Nov. 14, 2019

(30) Foreign Application Priority Data
Nov. 15, 2018 (DE) 10 2018 219 515.3

(51) Int. Cl. F16C 19/54; F16H 48/42

(52) U.S. Cl. CPC F16C 19/547; F16H 2048/423; F16H 48/42

(57) ABSTRACT

The invention relates to a bearing arrangement for a bevel gear drive, comprising a housing (14), a pinion (12), which includes a pinion shaft (12a) and a bearing journal (12b), and a crown wheel (13), which is meshed with the pinion (12), wherein the pinion (12) is supported with respect to the housing (14) via the bearing journal (12b) and the pinion shaft (12a) with the aid of antifriction bearings (15, 16).

It is provided that the pinion (12) is supported via two tapered roller bearings (15, 16) pitched with respect to one another, wherein the first tapered roller bearing (15) is arranged on the bearing journal (12b) and the second tapered roller bearing (16) is arranged on the pinion shaft (12a) and their pressure lines (d) form an X arrangement.

### CROSS-REFERENCE TO RELATED APPLICATION

The present application is related and has right of priority to German Patent Application No. 10 2018 219 515.3 filed on Nov. 15, 2018, the entirety of which is incorporated by reference for all purposes.

### FIELD OF THE INVENTION

The invention relates generally to a bearing arrangement for a bevel gear drive, an application of the bearing arrangement, and an axle transmission for motor vehicles.

### BACKGROUND

In known axle transmissions, in particular differentials for motor vehicles, a bevel gear drive is installed, which includes a driving pinion shaft with a bevel gear pinion and a crown wheel. The bevel gear drive forms a part of the differential gear or differential. In the known axle transmission, the pinion and the pinion shaft are supported with respect to a housing by three antifriction bearings in total, namely a first antifriction bearing arranged on a bearing journal of the pinion arranged on the end face, and a pair of tapered roller bearings arranged on the pinion shaft. The two tapered roller bearings are pitched with respect to each other in an O arrangement and, therefore, absorb axial and radial forces, which act on the pinion. The O arrangement is characterized in that the pressure lines, which extend perpendicularly to the longitudinal axes of the tapered rollers, extend away from each other and, therefore, form a stylized “O”.

### SUMMARY OF THE INVENTION

One example object of the invention is to further improve a bearing arrangement of the type described above.

According to a first example aspect of the invention, in a bearing arrangement for a bevel gear drive, a bearing is provided, which includes only two tapered roller bearings, which are pitched with respect to each other and are arranged on both end faces of the bevel gear pinion, wherein pressure lines of the two tapered roller bearings form an X arrangement. As compared to the prior art described above, the advantage is achieved that a bearing is saved, which results in advantages in terms of cost, weight, and installation space. Generally, the known O arrangement has the advantage that, due to the pressure lines extending away from one another, a wider base is formed and, therefore, a greater tipping torque can be absorbed. This does not disadvantageously affect the approach according to example aspects of the invention having an X arrangement of two tapered roller bearings, since the two tapered roller bearings also form a relatively wide base, due to the spatial separation of the two tapered roller bearings resulting from the width of the pinion. The relatively wide base is sufficient for absorbing a tipping torque occurring during operation. Therefore, an exact meshing of teeth and a sufficient service life of the bearings are ensured.

According to an advantageous example embodiment of the invention, the pressure lines, which extend away from the rolling elements (tapered rollers), form points of intersection on the longitudinal axis of the pinion shaft, which form a spacing distance, which is typical for the X arrangement and is a measure for the amount of tipping torque that can be absorbed. In the arrangement of the tapered roller bearings according to example aspects of the invention on both end faces of the pinion, a spacing distance or a base for the X arrangement results, which corresponds to the width or the axial extension of the pinion. Therefore, this base is not smaller, but rather is approximately the same size as in the prior art. This means that, despite the X arrangement, a sufficiently great tipping torque can be absorbed by the bearing of the pinion according to the invention.

According to further preferred example embodiments, the inner rings of the tapered roller bearings are supported on the end faces of the pinion and the outer rings of the tapered roller bearings are supported on the housing. The result is a compact design having shortened installation space in the longitudinal direction of the pinion shaft and a stiff bearing of the pinion.

According to a further example aspect of the invention, the bearing arrangement is utilized for an axle transmission, in particular a differential or an interwheel differential of a motor vehicle, preferably of a commercial vehicle. In this case, savings of installation space, weight, and cost are particularly advantageous: For example, lower unsprung masses result in increased ride comfort in busses.

According to a further example aspect of the invention, the bearing arrangement according to the invention is provided in an axle transmission for motor vehicles, in particular for commercial vehicles. The axle transmission includes, in addition to the bevel gear drive including pinion and crown wheel as well as the housing, a differential case, which is driven by the crown wheel and includes a bevel gear differential, by way of which the drive of the two axle shafts for the driving wheels of the motor vehicle takes place. The aforementioned advantages apply for the axle transmission in the same way.

### BRIEF DESCRIPTION OF THE DRAWINGS

An exemplary embodiment of the invention is represented in the drawing and is described in greater detail in the following, wherein further features and/or advantages can result from the description and/or the drawing. In the drawing

FIG. 1 shows a pinion bearing for an axle transmission according to the prior art,

FIG. 2 shows a bearing arrangement according to example aspects of the invention for a bevel gear pinion, and

FIG. 3 shows an axle transmission or differential including the bearing arrangement according to example aspects of the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

FIG. 1 shows a section of an axle transmission 1 including a known bearing arrangement for a bevel gear pinion 2, or pinion 2, which is meshed with a crown wheel 3 (partially represented). The pinion 2 includes a pinion shaft 2a and a bearing journal 2b arranged on the end face. The pinion 2 is supported with respect to a housing 4 via three antifriction bearings 5, 6, 7. The first antifriction bearing 5 is arranged on the bearing journal 2b, and a pair of tapered roller bearings 6, 7 are arranged on the pinion shaft 2a. The tapered roller bearings 6, 7 are arranged in an O arrangement, i.e., pressure lines d of the tapered roller bearings 6, 7 extend, from both bearings 6, 7, in opposite directions and form a stylized “O”. The points of intersection A, B of the pressure lines d with the longitudinal axis a of the pinion shaft 2a form a spacing distance c, or base c. The base c is a measure for the amount of tipping torque that can be absorbed: the larger the base, the greater the tipping torque.

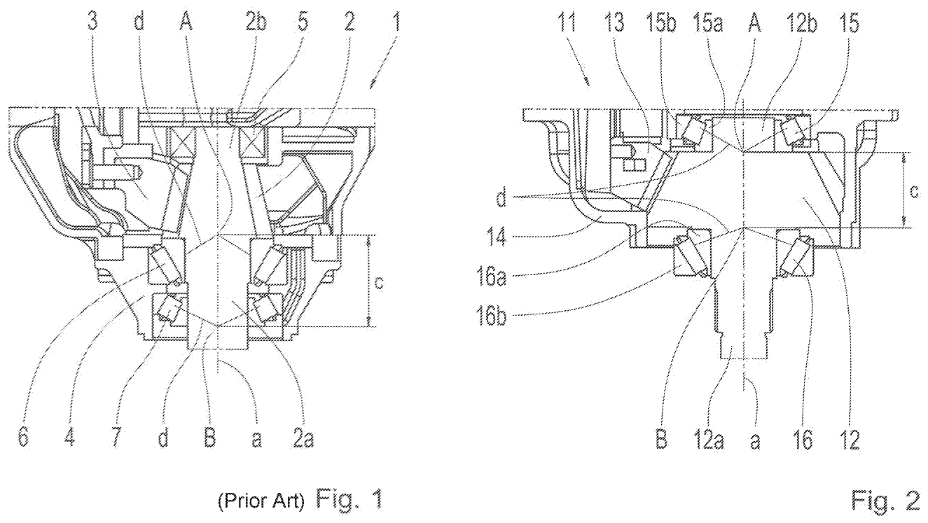

FIG. 2 shows an axle transmission 11 (partially represented) including a bearing arrangement according to example aspects of the invention for a pinion 12, which is meshed with a crown wheel 13. The pinion 12 includes a pinion shaft 12a and a bearing journal 12b on the end face. The pinion 12 is supported with respect to the housing 14 via two tapered roller bearings 15, 16. The first tapered roller bearing 15 is arranged on the bearing journal 12b and the second tapered roller bearing 16 is arranged on the pinion shaft 12a. The tapered roller bearings 15, 16 form, via pressure lines d of the tapered roller bearings 15, 16, an X arrangement. The pressure lines d intersect the longitudinal axis a of the pinion shaft 12a at the points A, B, which have a spacing distance c. This spacing distance c, or base c, corresponds to the width of the pinion 12, measured in the direction of the longitudinal axis a. The tapered roller bearings 15, 16 include inner races or rings 15a, 16a, respectively, and outer races or rings 15b, 16b, respectively. The inner rings 15a, 16a rest against the end faces of the pinion 12, while the outer rings 15b, 16b are supported on the housing 14 (the part of the housing 14 for supporting the outer ring 16b is not represented—it could be designed as a bearing cover). The two tapered roller bearings 15, 16 are therefore pitched with respect to one another in an X arrangement, wherein the pinion 12 is clamped between the inner rings 15a, 16a.

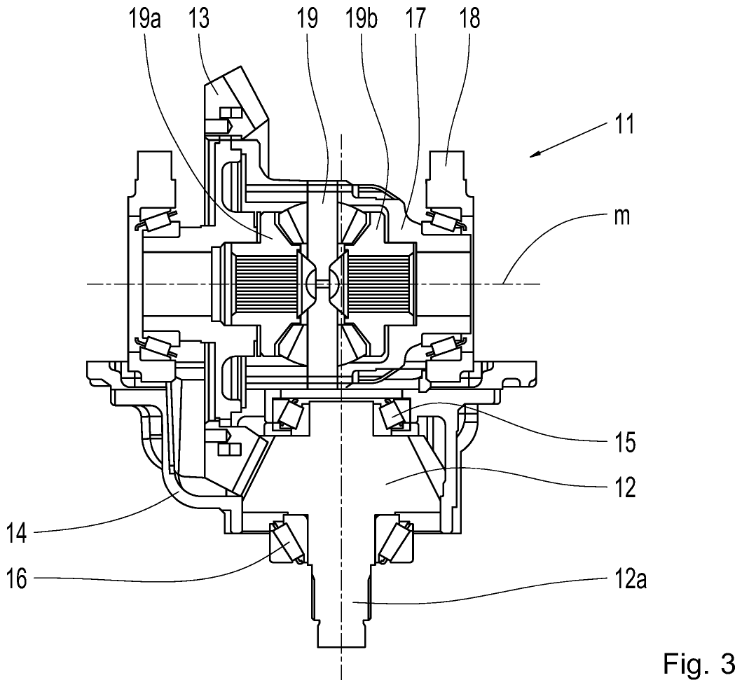

FIG. 3 shows a completed axle transmission 11 including a crown wheel 13 (completely represented), which is mounted, together with a differential case 17, in a further housing part 18. A bevel gear differential 19 is arranged within the differential case 17, wherein the bevel gears 19a, 19b arranged coaxially to a center line m accommodate, in a rotationally fixed manner, the inner ends of drive shafts (not represented) of a motor vehicle axle, preferably the rear axle of a commercial vehicle.

The drive of the axle transmission 11 takes place via the pinion shaft 12a and the pinion 12, which is supported in the housing 14 via the two tapered roller bearings 15, 16 and drives the crown wheel 13 including the differential case 17. The housing 14 is connected to the housing part 18. The axle shafts (not represented) and the driving wheels of the motor vehicle are driven via the differential 19.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE NUMBERS

1 axle transmission (prior art)
2 pinion
2a pinion shaft
2b bearing journal
3 crown wheel
4 housing
5 antifriction bearing
6 first tapered roller bearing
7 second tapered roller bearing
11 axle transmission
12 pinion
12a pinion shaft
12b bearing journal
13 crown wheel
14 housing
15 first tapered roller bearing
15a inner ring
15b outer ring
16 second tapered roller bearing
16a inner ring
16b outer ring
17 differential case
18 housing part
19 bevel gear differential
19a bevel gear, left
19b bevel gear, right
a pinion shaft longitudinal axis
A point of intersection
B point of intersection
c spacing distance AB (base)
d pressure line
m axle shaft center line

1-6: (canceled)

7. A bearing arrangement for a bevel gear drive, comprising:
a housing (14);
a pinion (12) comprising a pinion shaft (12a) and a bearing journal (12b); and
a crown wheel (13) meshed with the pinion (12),
wherein the pinion (12) is supported with respect to the housing (14) by the bearing journal (12b) and the pinion shaft (12a),
wherein the pinion (12) is supported by two tapered roller bearings (15, 16) pitched with respect to each other, a first tapered roller bearing (15) of the two tapered roller bearings (15, 16) is arranged on the bearing journal (12b), a second tapered roller bearing (16) of the two tapered roller bearings (15, 16) is arranged on the pinion shaft (12a), and pressure lines (d) of the two tapered roller bearings (15, 16) form an X arrangement.

8. The bearing arrangement of claim 7, wherein the pressure lines (d) form points of intersection (A, B) on a longitudinal axis (a) of the pinion shaft (12a), the points of intersection (A, B) have a spacing distance (c), and the spacing distance (c) approximately corresponds to a length of the pinion (12) along the longitudinal axis (a).

9. The bearing arrangement of claim 7, wherein each of the two tapered roller bearings (15, 16) comprise a respective inner ring (15a, 16a), and each of the inner rings (15a, 16a) is supported on a respective face of the pinion (12).

10. The bearing arrangement of claim 7, wherein each of the two tapered roller bearings (15, 16) comprise a respective outer ring (15b, 16b), and the outer rings (15b, 16b) are supported on the housing (14).

11. A differential (11) for a commercial motor vehicle, comprising the bearing arrangement of claim 7.

12. An axle transmission for a commercial motor vehicle, comprising the bearing arrangement of claim 7.
